(19) United States
(12) Patent Application Publication
(10) Pub. No.: US 2015/0294459 A1
(43) Pub. Date: Oct. 15, 2015

(54) Method and Apparatus for the Biopsy and Diagnosis of Precancerous Inflammation and Crohn's Inflammatory Bowel Disease

(71) Applicant: CDx Diagnostics, Inc., Suffern, NY (US)

(72) Inventors: Mark Rutenberg, Monsey, NY (US); Stephen Frist, Maleh Adumim (IL)

(21) Appl. No.: 14/685,500

(22) Filed: Apr. 13, 2015

Related U.S. Application Data
(60) Provisional application No. 61/979,078, filed on Apr. 14, 2014.

(51) Int. Cl. G06T 7/00; G06K 9/00

(52) U.S. Cl. CPC G06T 7/0012; G06K 9/00134; G06T 2207/10056; G06T 2207/30024

(57) ABSTRACT

A method and apparatus for determining a likelihood of Crohn's, quantifying a degree of Crohn's disease or determining a heightened cancer risk by analyzing a cell preparation of cell collected from a patient's GI tract. The GI tract cellular sample is fixed on a microscope slide and analyzed by a microscope combined with an image acquisition system and a computer having an image recognition system. The image recognition system detects inflammatory cells that are implicated in the body's inflammatory response and counts how many of such cells are on the slide. The computer generates an absolute number of such cells and percentage values for such cells out the total number of inflammatory cells classified. The computer then utilizes the absolute numbers, the ratios of inflammatory cells with respect to each other—or a combination of both to generate a score. The score represents a probabilistic determination of disease or a quantification of disease or pre-disease.

### RELATED APPLICATIONS

This Application claims the benefit of pending U.S. Prov. Appl. Ser. No. 61/979,078 filed on Apr. 14, 2014—the contents of which are incorporated by reference herein.

### BACKGROUND OF THE INVENTION

Crohn's disease, also known as regional enteritis, is an inflammatory bowel disease, which causes a wide variety of debilitating symptoms including abdominal pain, diarrhea, vomiting and weight loss. The most serious complication, however, is colorectal cancer. The development of cancer is related to the duration of Crohn's disease, the amount of time the colon has been exposed to inflammation. Crohn's disease affects between 400,000 and 600,000 people in North America. (1) Prevalence estimates for Northern Europe have ranged from 27-48 per 100,000. (2)

Moreover, the potential value of earlier diagnosis of precancerous changes in Crohn's patients is a recurrent goal of modern medicine. The concept of the present diagnostic approach is based on the idea that inflammation is causative in carcinogenesis. This is an accepted hypothesis in many body sites, for example in lung cancer. Furthermore, inflammation antecedes the dysplastic epithelial changes, presently considered the hallmark of early carcinogenesis, in leading to cancer. The computerized analysis of brush biopsies of the colon provides a quantitave measure of inflammation and relates that to a predictive index for future cancer risk.

Currently, the prediction of which patients will develop cancer is aimed at finding changes in the lining epithelium that antedate cancer. Dysplasia, the cellular change noted in mucosal biopsies of the colon, is generally accepted as the precursor of cancer. This change is a biopsy diagnosis, a qualitative determination rendered by pathologists. The lack of accuracy and reproducibility of results has led to research investigating supplemental modes for assessing dysplasia. One study found that immunostaining for alpha-methylocyl-Coa-racemase (AMACR), a mitochondrial and peroxisomal enzyme overexpressed in many types of cancers, was highly specific for detecting dysplasia. (3) Other molecular markers of interest in confirming dysplasia are beta catenin and P53. (4) Nevertheless, the conclusion of the value of these efforts is that the effectiveness of surveillance of dysplasia in patients with Crohn's disease is not uniform and only suggests a reduction in mortality from colorectal cancer.

In addition, in the current state of the art, it is difficult to classify or quantify Crohn's disease. As a result, it may be difficult to determine whether or not a Crohn's condition is responsive to drug therapy and it also is difficult to determine the degree of responsiveness to drug therapy.

### SUMMARY OF THE INVENTION

To address the problems associated with traditional Crohn's detection, the current invention utilizes a microscope combined with a computer image processing system to identify and generate counts of inflammatory cells found within a GI cytology preparation. This novel quantitative analysis can be used to identify individuals with Crohn's disease, quantify a degree of inflammation associated with Crohn's disease and determine a likelihood of an inflammatory process leading to a dysplastic or cancerous condition.

The image recognition system, using well known morphological characteristics, detects the presence of at least two, and up to five important inflammatory blood cell types, namely: polymorphonuclear leukocytes (PMN's), macrophages, lymphocytes, plasma cells and multinucleated giant cells in the colonic mucosal specimen. The system then counts the number of each of these cell types in the sample vis-à-vis the total number of cells on the slide to determine a percentage value for each of the cell types. Using the percentage values for at least two of the inflammatory cell types, a probabilistic determination of the presence of Crohn's disease and/or precursor to dysplasia is rendered.

In a preferred embodiment of the invention, a probabilistic determination of the presence of Crohn's is made through a two dimensional analysis wherein a percentage value for at least two cells types are plotted as the x and y axis of a graph with the z axis representing the probability of the condition. Preferably, percentage values of PMNs and lymphocytes are plotted to determine a probability and/or a degree of Crohn's.

Most preferably, the computer calculates a probability score based on the combined x and y values described above. The probability score will be on a scale—increasing when high percentages of immune cells are detected and vice versa.

The invention presents an improvement over the state of the art in many significant ways. First, rather than a “gestalt” approach to cellular analysis as is currently practiced in the art, the inventive system introduces a level of objectivity and quantification to the diagnosis of inflammation. Moreover, because the system produces an actual percentage of cells, a treating clinician is given the benefit of a baseline with which to compare subsequent test results.

It should be noted that the even though the term “Crohn's disease” is predominantly used herein, the invention set forth is used to detect various inflammatory diseases such as Crohn's, colitis, IBD and a condition associated with a heightened risk of cancer.

### BRIEF DESCRIPTION OF THE DRAWINGS

FIG. 1 is a schematic showing the shortcomings of two-dimensional analysis.

FIG. 2 is a schematic representation of a three-dimensional analysis for Crohn's or precancer according to an embodiment of the invention.

### DETAILED DESCRIPTION OF THE INVENTION

Embodiments of the present invention will now be described with reference to the above-identified figures of the Drawings. However, the Drawings and the description herein of the invention are not intended to limit the scope of the invention. It will be understood that various modifications of the present description of the invention are possible without departing from the spirit of the invention. Also, features described herein may be omitted, additional features may be included, and/or features described herein may be combined in a manner different from the specific combinations recited herein, all without departing from the spirit of the invention.

The pathologic features that characterize Crohn's Disease include a transmural inflammatory infiltrate; the process spans the entire thickness of the intestinal wall. The most involved region is the mucosa, which leads to ulcerations in highly active disease. The mucosal inflammation is characterized by focal infiltration of polymorphonuclear neutrophils. Typically, these cells overlie aggregates of mature lymphocytes. Another inflammatory component is granuloma formations, consisting of mononuclear cells, macrophages and multinucleated giant cells.

Inflammation in Crohn's disease is characterized by an alteration in the number and proportion of the inflammatory cells described above. The current microscopic method for assessing the inflammatory process is based on a pathologist's qualitative interpretation of the mucosal specimen. By inspecting the slide, the pathologist forms an impression as to what cells lines are present and whether they are increased/normal/decreased in number on an absolute basis, and whether they are increased/normal/decreased in relation to the other cellular constituents.

This type of perceptual analysis—difficult in any situation—is rendered more difficult in the specific circumstances of intestinal cytology. Firstly, the cell types are not uniformly dispersed. There are always areas of increased density and other areas of paucity of each cell line. Another shortcoming of the current microscopic analysis derives from its lack of quantification. The subjective nature of the diagnosis does not allow for comparison of progression or regression over time. Once the diagnosis of Crohn's disease is established, it is important to follow the progress of the disease and its response to therapy. A qualitative microscopic diagnosis limits the ability to accomplish this important objective.

To address the problems associated with diagnosing crohn's and other similar gastrointestinal diseases, the instant inventors developed a system, which utilizes a microscope combined with a computer image processing system to identify and generate counts of inflammatory cells found within a colon brush biopsy preparation.

A retractable brush is threaded into a colonoscope and is used to obtain cells from the lining of the GI tract. The brush head is then wiped against a glass slide—transferring cells thereto. The slide is then analyzed with an image recognition system which classifies the types of cells present on the slide and counts how many of each cell type is present.

The image recognition system, using well known morphological characteristics, detects the presence of the various inflammatory blood cell types, namely: polymorphonuclear leukocytes (PMN's), macrophages, lymphocytes, plasma cells and multinucleated giant cells in the colonic mucosal specimen. The system then counts the number of each of these cell types in the sample vis-à-vis the total number of cells on the slide to determine a percentage value for each of the cell types. Finally, a probabilistic determination of the patient's future cancer risk to the patient is determined using the percentage values of the cells types. The system for the probabilistic determination is based on a two dimensional analysis wherein a percentage value for at least two cells types are plotted as the x and y axis of a graph with the z axis representing the probability of the condition. Most preferably, the computer calculates a probability score based on the combined x and y values described above. The probability score represents a data point on a continuum.

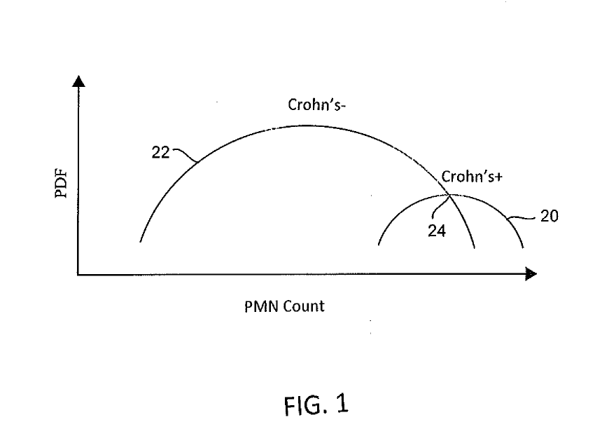

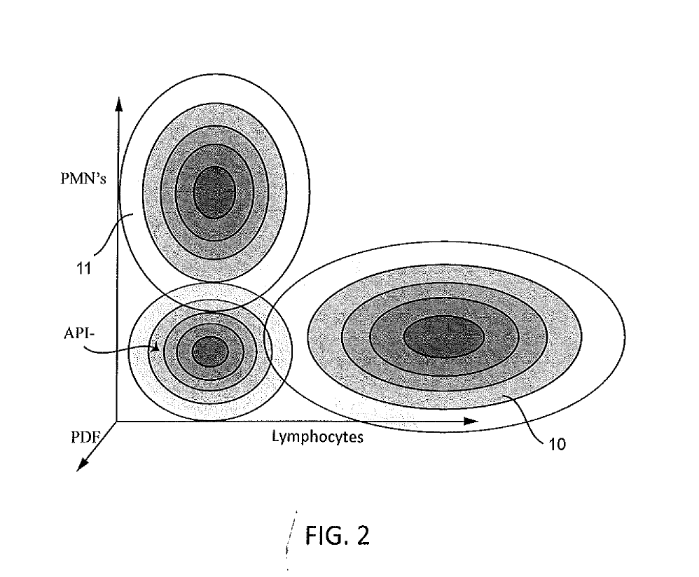

In a preferred embodiment, in order to yield a probability or a quantitative value of Crohn's, a minimum of two parameters are examined. For example, to determine a probability of Crohn's, the system will determine whether or not each of PMNs and lymphocytes are present at elevated levels. This is referred to as a three-dimensional analysis. Analysis of a single parameter (cell-type) may lead to over-calling disease. For example, referring to FIG. 1, which shows a plot of PMNs, Arc 20 shows a level of PMNs that may be associated with Crohn's. Arc 22 shows a range of PMNs within which a patient may be negative for Crohn's. In the area of overlap 24, a patient may be called positive for Crohn's when, in fact, he/she is negative for the condition. The same is true for lymphocytes (although not shown). However, when the two parameters are combined (as shown in FIG. 2) patients with Crohn's and/or a heightened index value for precancer/cancer are separated from those that are negative.

FIG. 2, schematically shows a three-dimensional analysis of the invention. A high number of lymphocytes PMNs, may in itself indicate Crohn's. However, it also is possible that there is no Crohn's. Similarly, an elevated number of lymphocytes 10, may or may not be as a result of Crohn's. However, when these two parameters are combined, patients that are positive for Crohn's (or with an elevated cancer risk index) are distinguished from those that are negative (or have no elevated cancer risk index)—with a high degree of accuracy. That is, either increased absolute numbers of PMNs and lymphocytes, or increased percentages of these cells with respect to each other or with respect to other inflammatory cells—or some combination of the two metrics—will allow for discrimination between patients that are negative and those that are positive for inflammation consistent with Crohn's or are rendered to have a high predictive index for future cancer risk. In one embodiment of the invention, if PMNs account for 75-95% of total inflammatory cells on a slide and lymphocytes account for 2-10% of total inflmmatory cells on a slide then a patient is determined to be positive for Crohn's. In addition, the cell percentage values serve as quantifiable baseline for which to compare future test results of this type.

In one preferred embodiment of the invention, five different cell types are recognized and percentage values for each are calculated. The following ranges of percentage values (out of total inflammatory cells present on the slide) indicates either a presence of Crohn's or an elevated risk of cancer:

PMNs 75-95% of total cells

Macrophages—5-10% of total cells

Lymphocytes—2-10% of total cells

Plasma cells—less that 5% of total cells.

Multinucleated Giant Cells (MGCs)—less than 2% of total cells.

The method described presents an improvement over the current medical method in many significant ways. First, rather than a subjective “gestalt” approach to colon biopsy analysis as is currently practiced; the inventive system introduces a level of objectivity and reproducibility to the diagnosis of inflammation. Moreover, because the system produces an actual percentage of cells, a treating clinician is given the benefit of a baseline with which to compare subsequent test results.

Having described this invention with regard to specific embodiments, it is to be understood that the description is not meant as a limitation since further modifications and variations may be apparent or may suggest themselves to those skilled in the art. It is intended that the present application cover all such modifications and variation as fall within the scope of the appended claims.

What is claimed is:

1. A method of determining a Crohn's condition comprising the steps of:
examining a slide comprising a cellular sample collected from a GI tract with a microscope combined with an image acquisition system;
acquiring images of cells in said cellular sample;
analyzing said images of said cells with an image recognition system to detect at least two types of inflammatory cells;
counting individual cells of each of said at least two types of inflammatory cells;
calculating a total number of inflammatory cells on said slide;
generating a first percentage value, said first percentage value corresponding to a percentage of said first inflammatory cell type out of said total number of inflammatory cells;
generating a second percentage value, said second percentage value corresponding to a percentage of said second inflammatory cell type out of said total number of inflammatory cells;
comparing said first percentage value to a first expected value and comparing said second percentage value to said to a second expected percentage value; and
generating a score based on said comparisons, said score indicating a likelihood of disease.
